(19) United States
(12) Patent Application Publication
(10) Pub. No.: US 2006/0150802 A1
(43) Pub. Date: Jul. 13, 2006

(54) System for use of a personal computer for performing music

(76) Inventor: James Allen Whiting, Nashville, TN (US)

Correspondence Address: James A. Whiting, 228 Nunley Dr., Nashville, TN, 37211, US

(21) Appl. No.: 11/169,391

(22) Filed: Jun. 28, 2005

Related U.S. Application Data
(60) Provisional application No. 60/583,860, filed on Jun. 28, 2004.

(51) Int. Cl. G10H 7/00

(52) U.S. Cl. 84/603

(57) ABSTRACT

A system for the polyphonic performance of music on a personal computer requiring no additional hardware to generate said music other than the standard hardware found in said personal computer in combination with a software program and lookup tables that enables one with no musical training to perform musical compositions and to accompany other musical performers.

This application claims the benefit of my earlier filed provisional patent application, Patent Application No. 60/583,860, filed on the date of Jun. 28, 2004.

### BACKGROUND OF INVENTION

In order to play music on a piano keyboard, music synthesizer keyboard or organ keyboard, it is necessary to memorize the appropriate finger movements or to be able to read music.

The need often arises, however, for a musical accompaniment when no one with necessary practice or training is available. A number of attempts to achieve this can be shown from prior art including the Magnus chord organ, the autoharp, the Thomas organ and the player piano.

### DESCRIPTION OF INVENTION

The present invention addresses this problem by adapting a personal or laptop computer so that a person with rudimentary typing skills can perform said musical accompaniment.

This is accomplished with specially designed software that translates standard computer keyboard key-strokes to musical format via a lookup table. Said software allows the opening of song or composition files that display a specific selection's notes and chords as standard computer keyboard symbols. The lookup/translation table in the software is strategically arranged to make playing a composition a concise and easy effort. As each note or chord is selected to be played, a pre-recorded file is sequentially reproduced through a computer sound card or module or by an interfaced midi sound module.

Alternatively, the performer may select to simply press a single key (for example, the space bar key) in rhythm to perform a musical selection.

This software enables the computer user to play a polyphonic sequence (for example, two-handed piano or organ) with a series of single keystrokes, each chord or single note being triggered by said single keystroke. There are potentially as many notes, chords or other samples as there are computer keyboard keys available that can uniquely be generated with a single keystroke. This invention is intended to emulate or take the place of a stand alone musical keyboard instrument. In addition, two drop screens (selected computer monitor window displays) are accessible, the first being a ‘Song Category’ screen, the second being a ‘Select Song’ screen. Lyrics and/or computer keyboard symbols appear for each composition selected. The user can:

Play the selected song in real time, striking the symbol that appears above each syllable in the song lyric or text, or, if there are no lyrics or text, striking the symbols in a tempo of the user's discretion;

‘Push’ the record button with his or her pointing device (for example, a mouse or trackball) and, as the user types out the symbols on the screen, those keys are recorded or sequenced for playback at the time intervals and tempos that were selected by the user;

User can elect to key in those symbols in the record mode using the space bar, each press of the space bar ‘playing’ the next symbol represented; song will then play back in the user selected time intervals or tempo;

Select a song to be played back automatically from a bank of pre-sequenced selections. Additionally, user can select a list of songs in the song bank to play automatically, either in random or in preselected order.

Said lookup table is used to call up specific data or sound files which are stored as binary data, “wav”, “mp3”, or other file formats as desired.

Means may also be included to allow a user of this invention to select from a number of voices or sounds and/or combinations of voices and sounds for performance or playback purposes.

This invention also includes means to record and play back a user's performance. This is accomplished by selecting and depressing a “Record” Button on the computer screen with said pointing device.

### DESCRIPTION OF DRAWINGS

FIG. 1 is a flowchart showing the ‘Initialization” algorithm of the preferred software.

FIG. 2 is a flowchart showing the “Recording” algorithm of the preferred software.

FIG. 3 is a flowchart showing the “Key Down” algorithm of the preferred software.

FIG. 4 is a flowchart showing the “Key Press” algorithm of the preferred software.

FIG. 5 is a flowchart showing the “Key Up” algorithm of the preferred software.

FIG. 6 is a flowchart showing the “Playback” algorithm of the preferred software.

FIG. 7 is a flowchart showing the “Play With Trace” algorithm of the preferred software.

FIG. 8 is a flowchart showing the “Play Chord” algorithm of the preferred software.

FIGS. 9, 10, 11, 12, 13, 14 and 15 show 61 polyphonic chords assigned to respective specific computer keyboard key examples in musical notation of one group of preferred note combinations represented by the computer keyboard.

FIG. 16 shows single notes assigned to respective specific computer keyboard key examples in musical notation of one group of preferred note combinations represented by the computer keyboard.

FIG. 17 shows a preferred embodiment of the opening computer monitor screen of said software.

FIG. 18 shows a preferred embodiment of the “Song Category” screen overlaying said opening screen.

FIG. 19 shows a preferred embodiment of the “Select Song” screen, along with a sample song, overlaying said opening screen.

FIG. 20 is an example of a preferred embodiment of the initial program screen with no selections made.

FIG. 21 is an example of a preferred embodiment of the program screen with a drop down selection screen.

FIG. 22 is an example of a preferred embodiment of the program screen with a song selected.

FIG. 23 is a chart showing an example of computer keyboard relationships to data files with reference to a musical instrument keyboard.

FIG. 24 is a flowchart showing the “Recording” algorithm including cap lock key sensing.

### DRAWINGS EXPLANATIONS

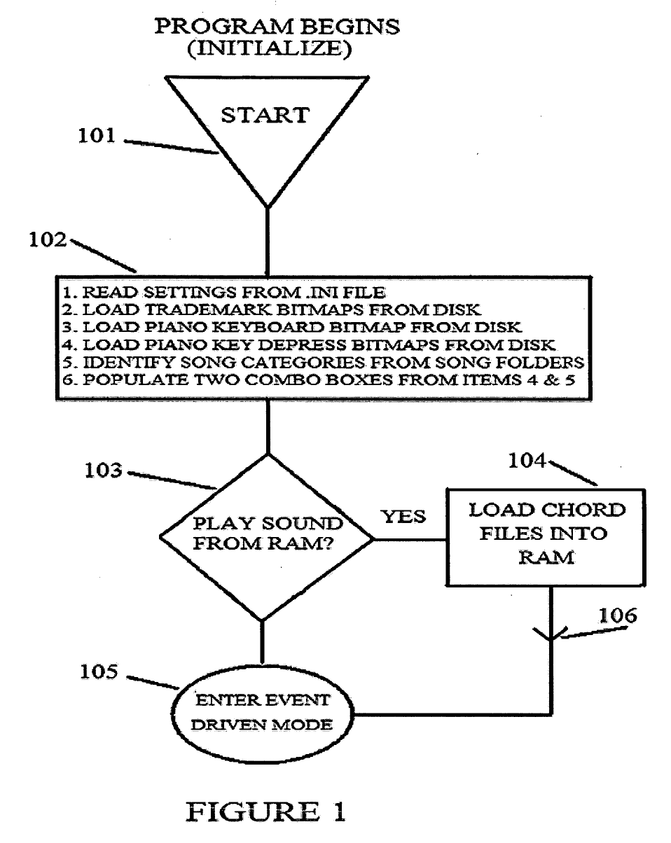

FIG. 1—Initialization Flow Chart

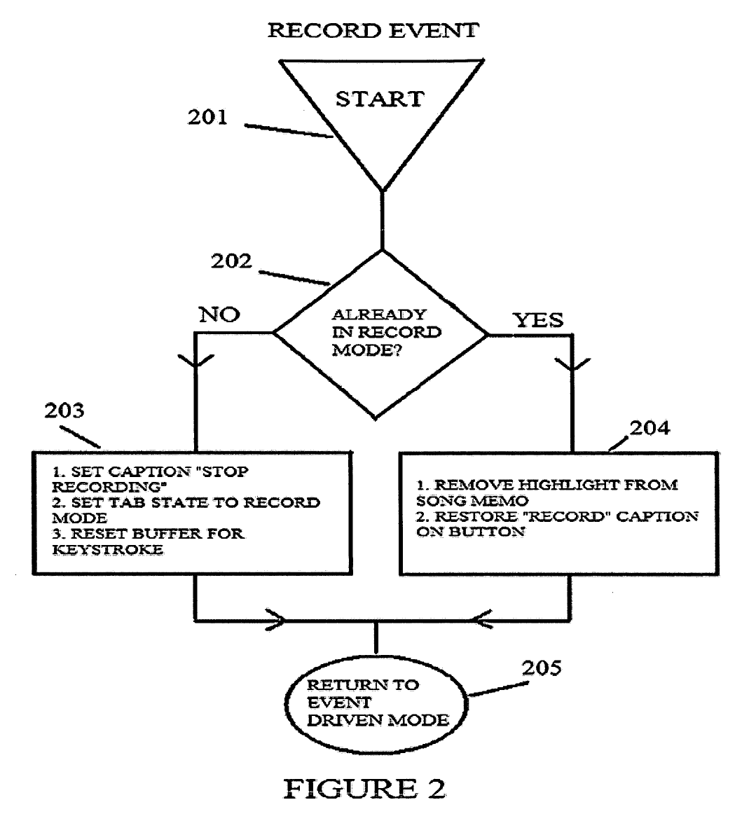

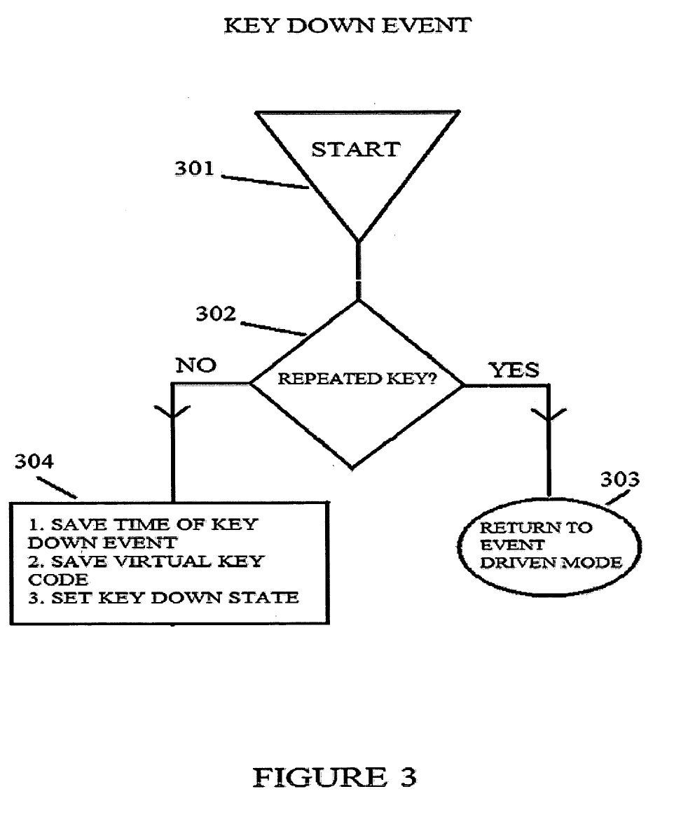

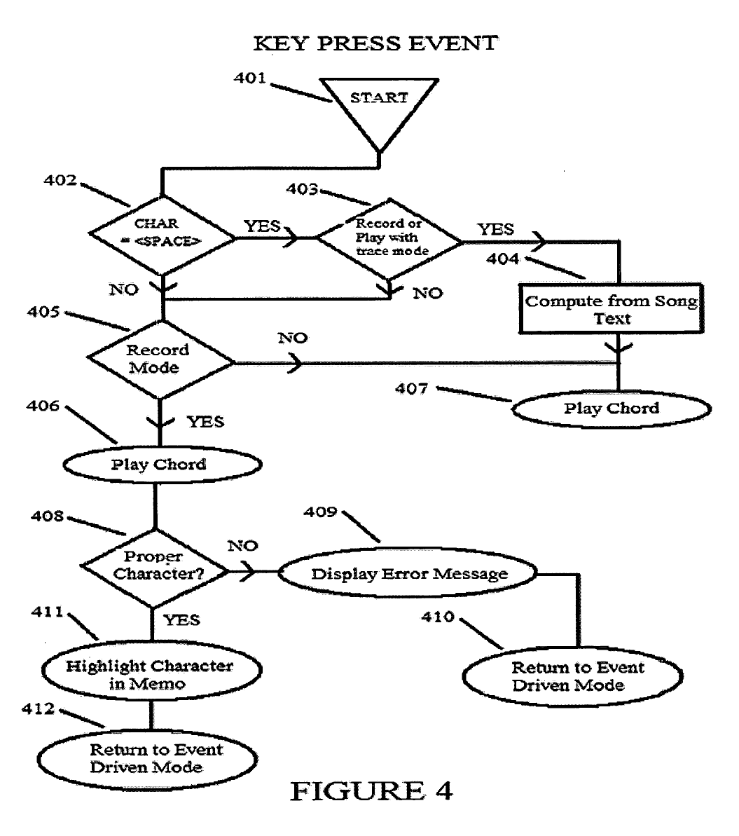

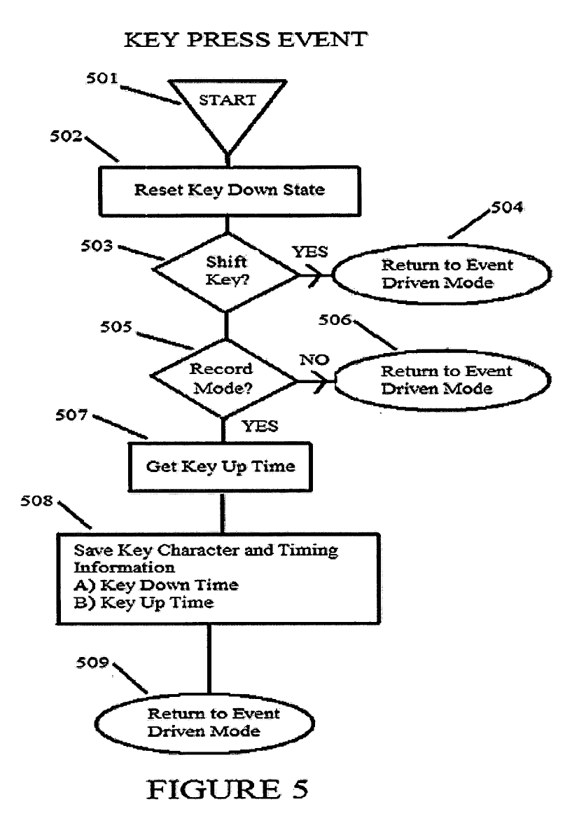

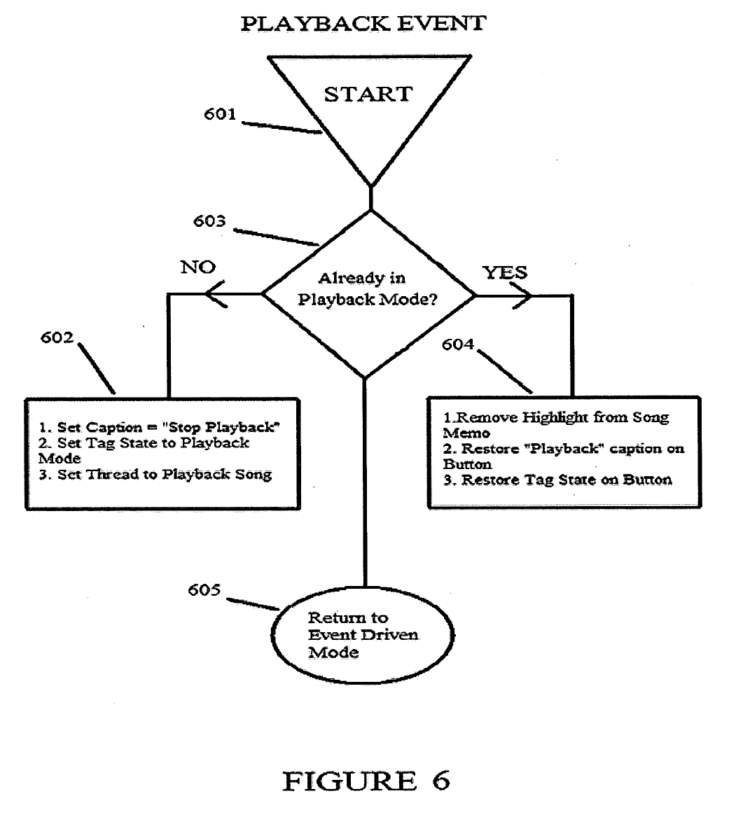

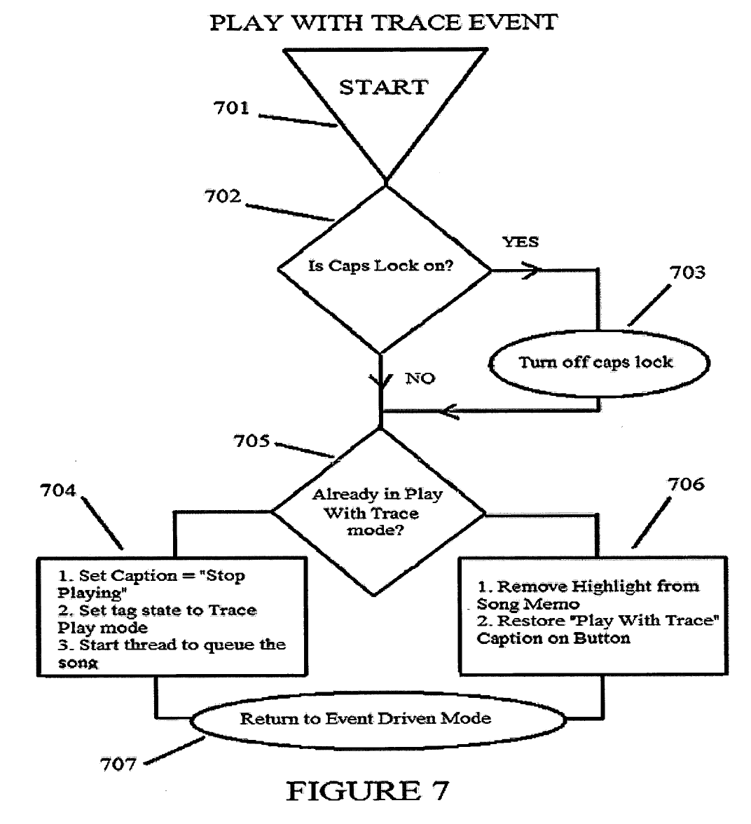

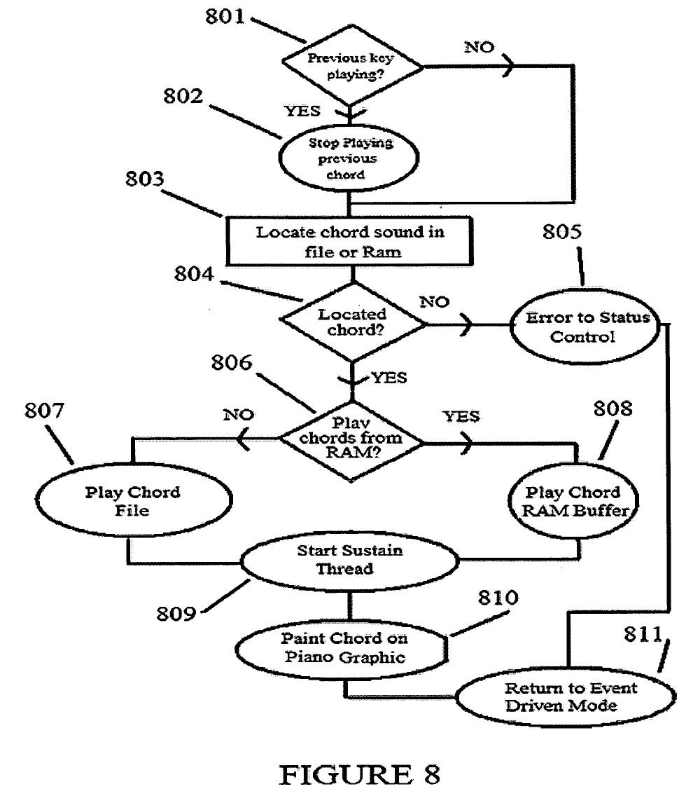

When the program starts, it instructs the computer to
Read settings from the ini file.
Load Trade Mark bitmap from disk or memory.
Load piano keyboard bitmap from disk or memory.
Load piano keys depress bitmap from disk or memory.
Identify song categories from song folders.
Identify song titles from files within each folder
Populate two combo boxes from items 5 and 6 above.
After initialization, the computer is instructed to look for two commands:
Load chord files into ram and go to the Event Driven Mode
or
Go Directly to the Event Driven Mode
   FIG. 2—Record Event Flow Chart
Upon entering the “Record Event” algorithm,
The computer is then instructed to to check to determine if the computer is or is not in the Record Mode.
If the Record Mode is on, the computer is instructed to
Remove Highlighting from a displayed Song Memo indication
and
Restore the “Record” caption on a displayed button.
Return to the Event Driven Mode.
If the Record Mode is NOT on,
Set Caption to “Stop Recording”
Set state to record mode
Reset Buffer for Key Stroke save.
   FIG. 3—Key Down Event
Upon entering the “Key Down Event” algorithm, the computer is instructed to check for a repeated key depression.
If this occurs, it is instructed to return to the “Event Driven” Mode.
If a key is not repeated, it is instructed to
Save the value of the time at which the key was depressed.
Save the Virtual Key Code.
and
Set the computer to the “Key Down” state.
   FIG. 4—Key Press Event Flow Chart
When a key is pressed, if it is the space bar and the system is in the “Record” or “Play with Trace Mode”, the next sequential key to be depressed on the keyboard is computed from the Song Text, the corresponding note or chord is played and the system is returned to the “Event Driven” mode.
If the space bar or another key is depressed and the computer is not in the “Record” or “Play With Trace” mode, a chord is automatically selected from the Song Text, played and the system is returned to the “Event Driven” Mode.
If the proper character has been depressed, the on screen symbol corresponding to that character is highlighted and the system is returned to the “Event Driven” Mode.
If the incorrect character has been depressed, an error message is displayed and the system is returned to thr “Event Driven” Mode.
   FIG. 5—Key Up Event
When a key is released, the “Key Down” state is reset and the keyboard is checked for depression of the shift key.
If the shift key is depressed, the system is returned to the “Event Driven” Mode.
If the shift key is not depressed and the system is not in the “Record” Mode, it is returned to the “Event Driven” Mode.
If the shift key is not depressed and the system is in the “Record” Mode, it retrieves the “Key Up” time, and saves the currently selected Key Character with its associated timing information including “Key Down” and “Key Up” event times.
The system is then returned to the “Event Driven” Mode.
   FIG. 6—Playback Event
When the “Playback” Button on the screen is selected and the system is in the “Playback” Mode
The highlight is removed from the Song Memo.
The “Playback” caption is restored to the “Playback” button.
The Tag state is restored on the “Playback” button.
and the system is returned to the “Event Driven” Mode.
When the “Playback” Button on the screen is selected and the system is not in the “Playback” Mode
A “Stop Playback” caption is displayed on the screen.
The Tag state is set to Playback Mode.
A Thread is started to Playback the Song.
and system is then returned to the “Event Driven” Mode.
   FIG. 7—Play With Trace Event
When the system is in the “Record” or “Playback” Mode, a scan is made to check for activation of the keyboard's Caps Lock function.
If the Caps Lock function is on, it is turned off
The system is then checked if it is already in the “play With Trace” Mode.
If in this mode,
The highlight is removed from the Song Memo display.
The “Play With Trace” is restored to the button.
The system is returned to the “Event Driven” Mode.
If not in the “Play With Trace” Mode,
A “Stop Playing” caption is displayed.
The Tag state is set to “Trace Play” Mode.
A Thread is started to Queue the Song.
The system is returned to the “Event Driven” Mode.
   FIG. 8—Play Chord

The “Play Chord” routine mutes any notes or chords occuring when a new key is depressed, locates the new corresponding note or chord in RAM, plays the selected notes, paints these notes selectively on a screen displayed piano keyboard and returns the system to the “Event Driven” Mode.

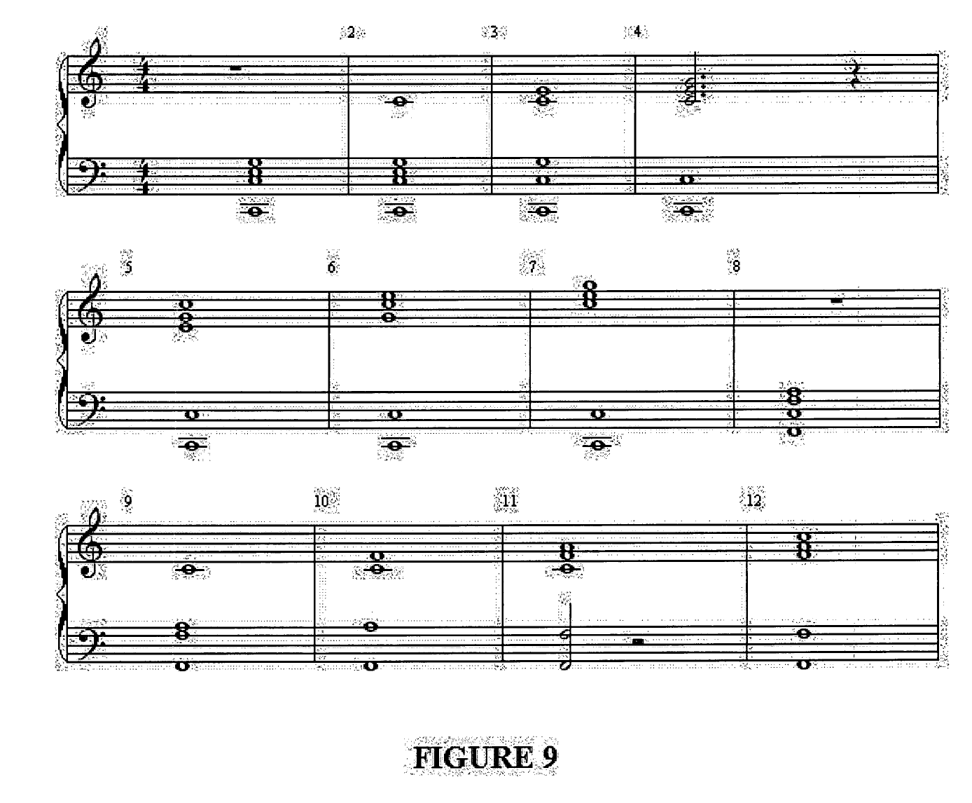

FIGS. 9 through 16 represent a preferred embodiment of chord and note assignments to the computer keyboard.

Chord Configurations:

FIG. 9

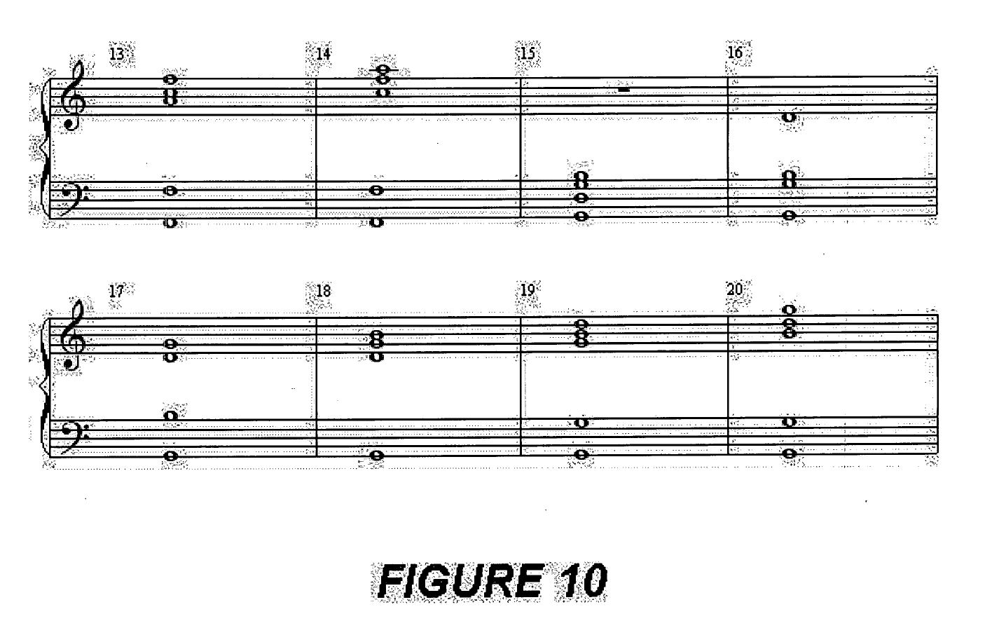

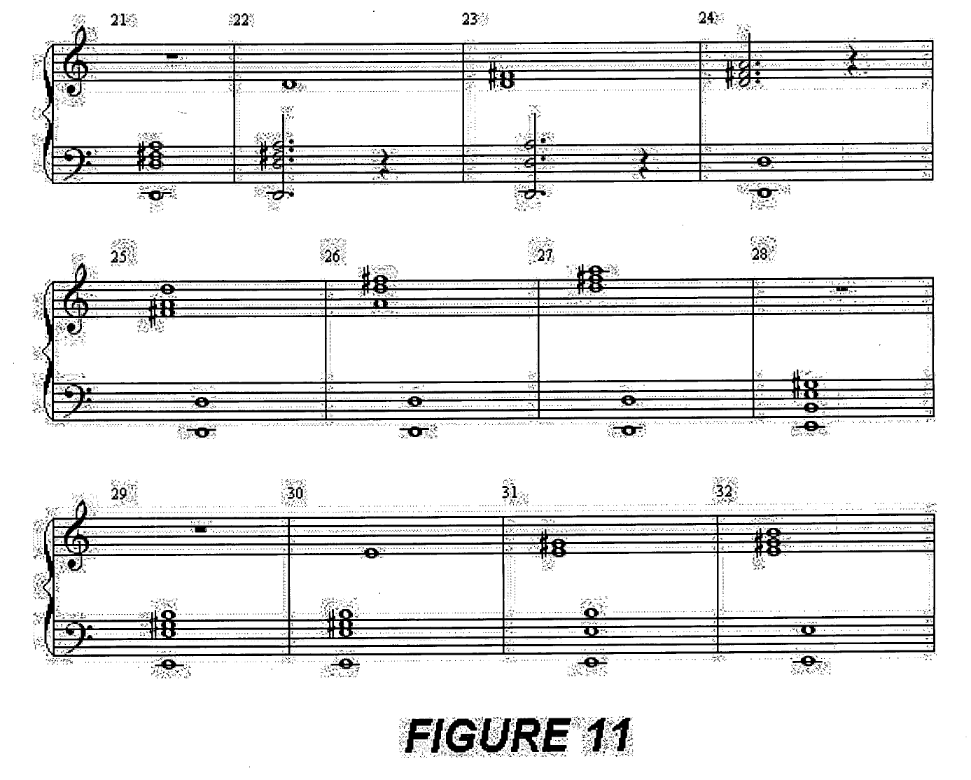

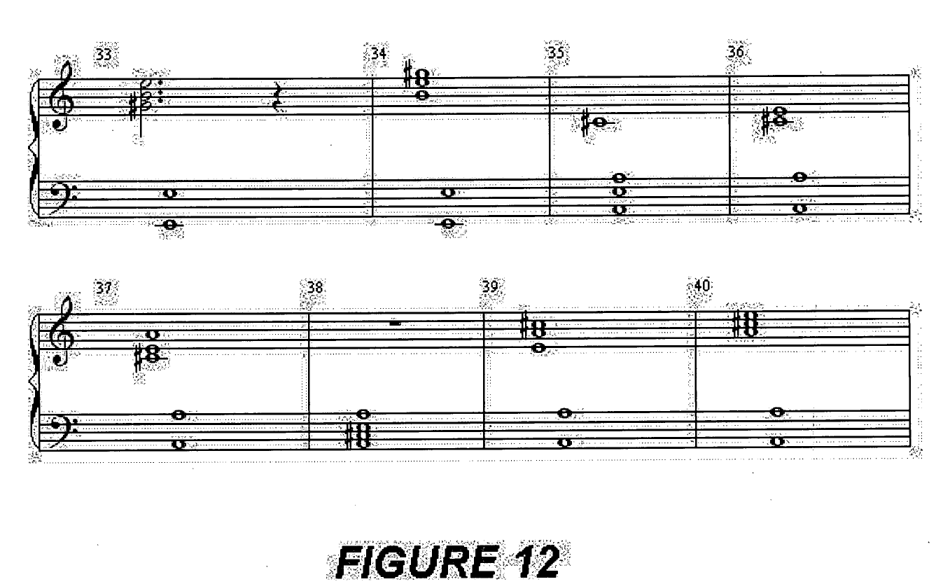

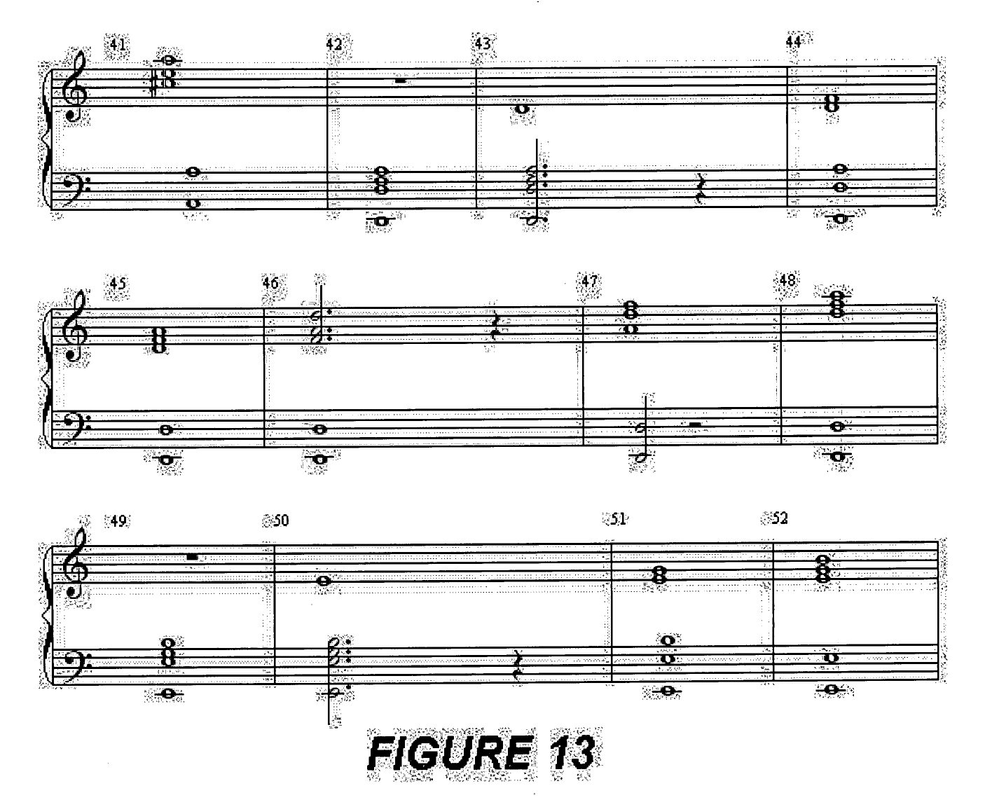

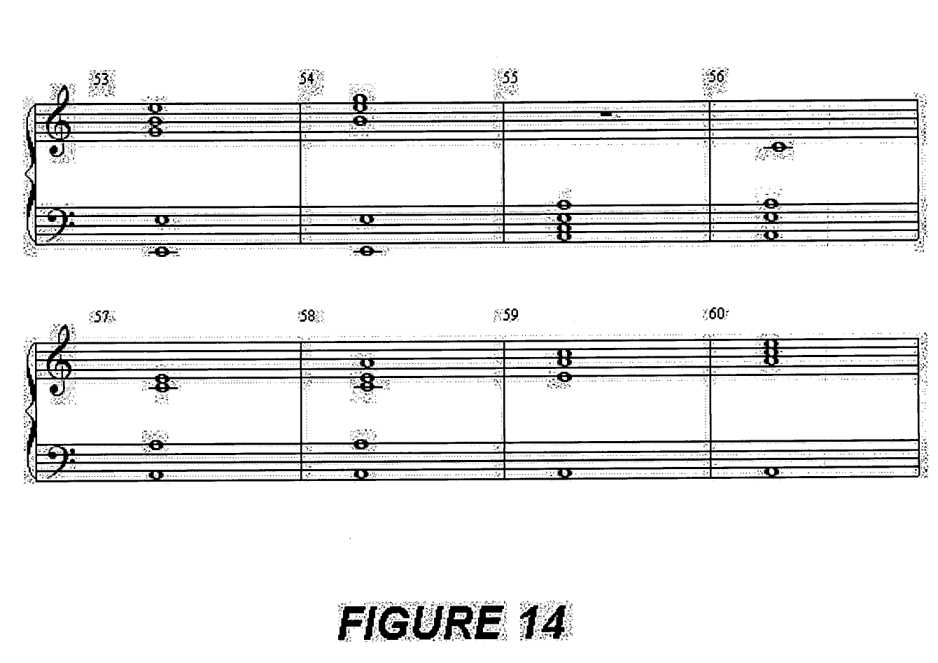

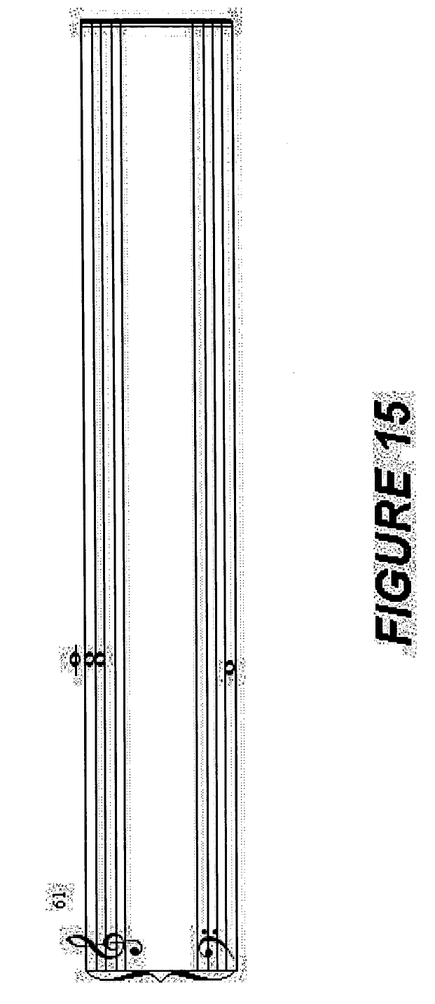

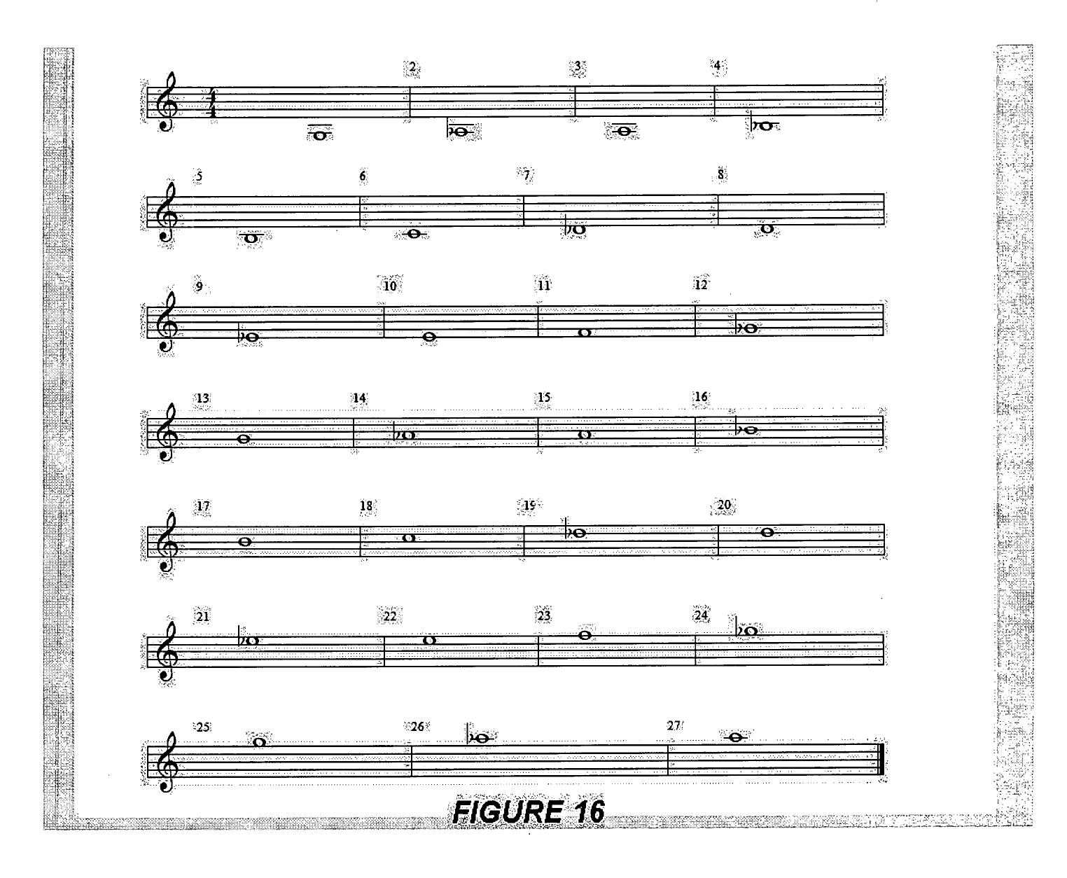

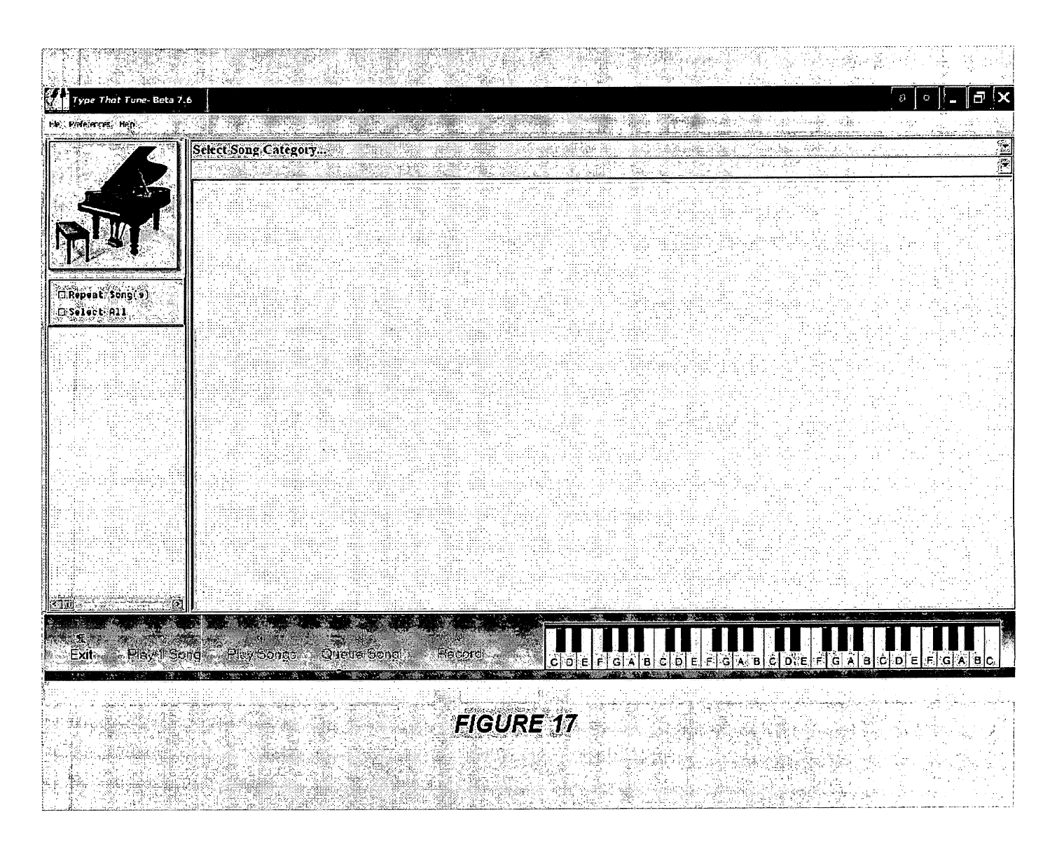

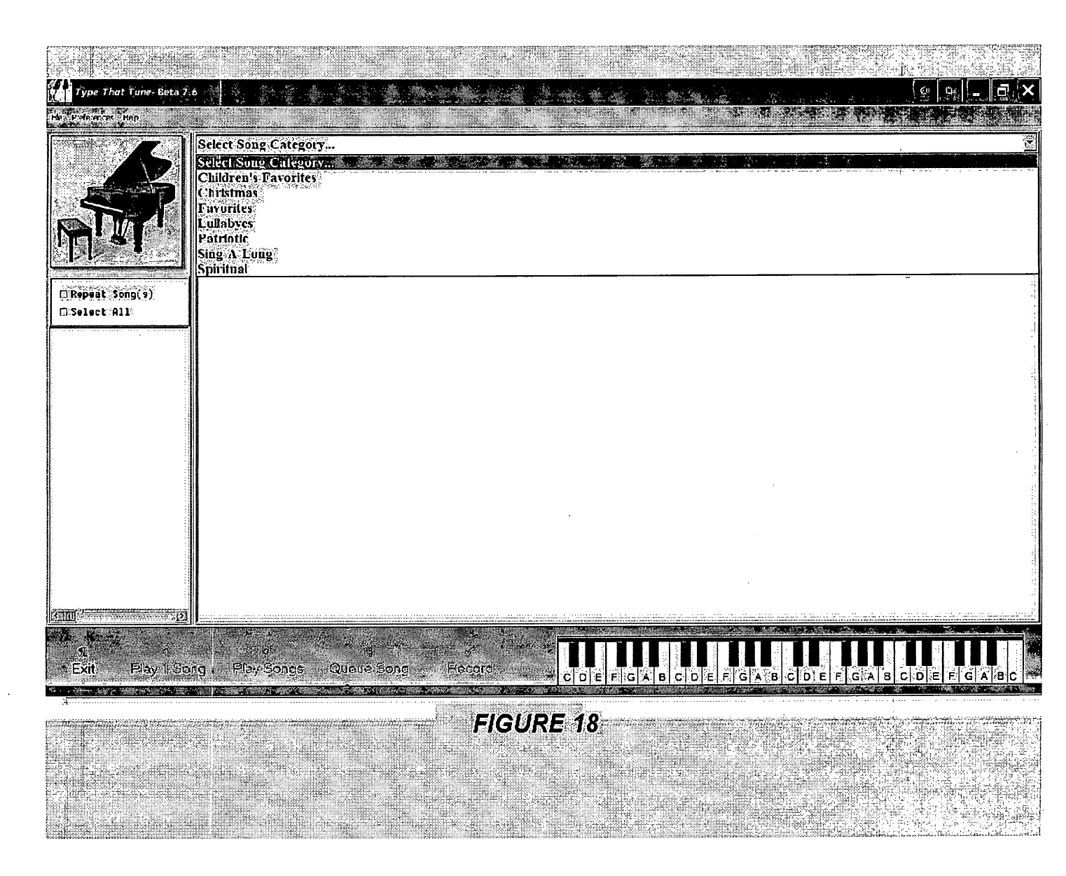

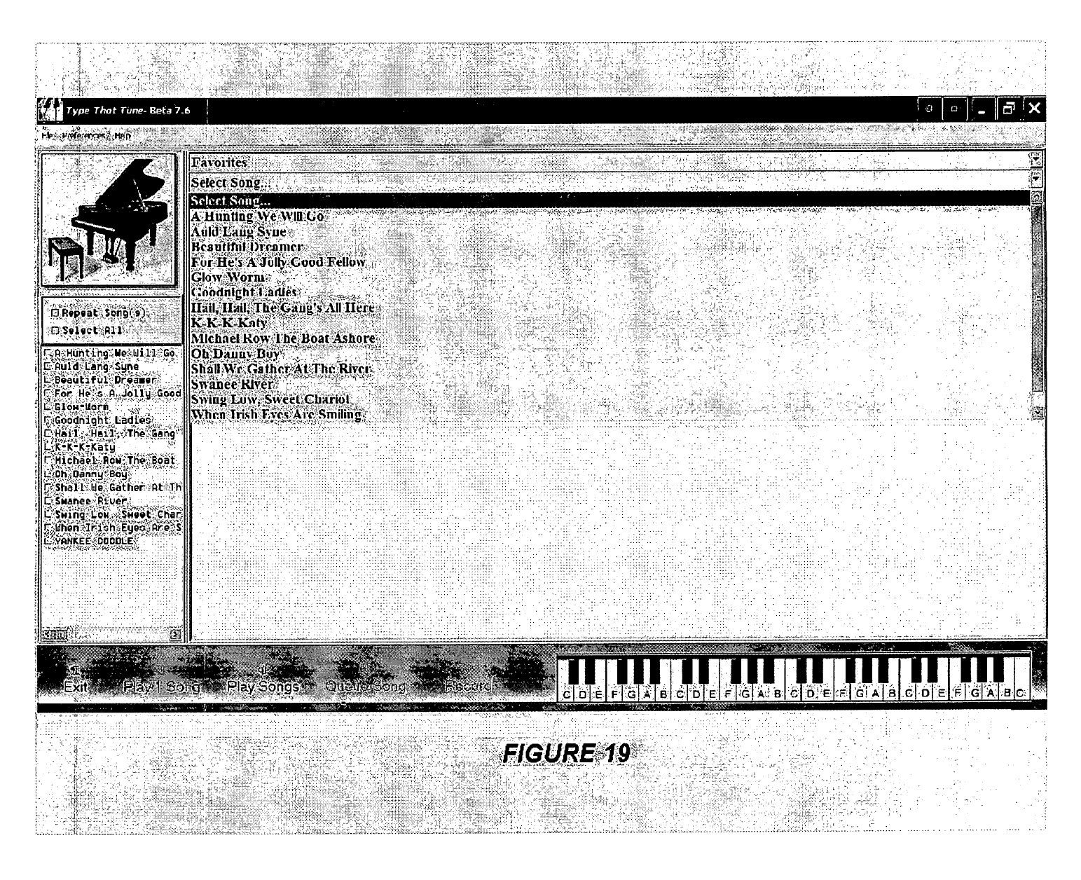

(Measures are numbered 1-61 and 1-26 respectively. Numbers following note designations denote the octave in which the note appears on the piano keyboard, with middle C being the first note of octave 3.)
Measure 1 is a C chord, with a top note of G2, triggered by the computer key ‘a’.
Measure 2 is a C chord, with a top note of C3, triggered by the computer key ‘b’.
Measure 3 is a C chord, with a top note of E3, triggered by the computer key ‘c’.
Measure 4 is a C chord, with a top note of G3, triggered by the computer key ‘d’.
Measure 5 is a C chord, with a top note of C4, triggered by the computer key ‘e’.
Measure 6 is a C chord, with a top note of E4, triggered by the computer key ‘f’.
Measure 7 is a C chord, with a top note of G4, triggered by the computer key ‘g’.
Measure 8 is an F chord, with a top note of A2, triggered by the computer key ‘h’.
Measure 9 is an F chord, with a top note of C3, triggered by the computer key ‘i’.
Measure 10 is an F chord, with a top note of F3, triggered by the computer key ‘j’.
Measure 11 is an F chord, with a top note of A3, triggered by the computer key ‘k‘.
Measure 12 is an F chord, with a top note of C4, triggered by the computer key ‘l’.
   FIG. 10
Measure 13 is n F chord, with a top note of F4, triggered by the computer key ‘m’.
Measure 14 is an F chord, with a top note of A4, triggered by the computer key ‘n’.
Measure 15 is a G chord, with a top note of B2, triggered by the computer key ‘o’.
Measure 16 is a G chord, with a top note of D3, triggered by the computer key ‘p’.
Measure 17 is a G chord, with a top note of G3, triggered by the computer key ‘q’.
Measure 18 is a G chord, with a top note of B3, triggered by the computer key ‘r’.
Measure 19 is a G chord, with a top note of D4, triggered by the computer key ‘s’.
Measure 20 is a G chord, with a top note of G4, triggered by the computer key ‘t’.
   FIG. 11
Measure 21 is a D chord, with a top note of A2, triggered by the computer key ‘u’.
Measure 22 is a D chord, with a top note of D3, triggered by the computer key ‘v’.
Measure 23 is a D chord, with a top note of F#3, triggered by the computer key ‘w’.
Measure 24 is a D chord, with a top note of A3, triggered by the computer key ‘x’.
Measure 25 is a D chord, with a top note of D4, triggered by the computer key ‘y’.
Measure 26 is a D chord, with a top note of F#4, triggered by the computer key ‘z’.
Measure 27 is a D chord, with a top note of A4, triggered by the computer key ‘1’.
Measure 28 is an E chord, with a top note of G#2, triggered by the computer key ‘2‘.
Measure 29 is a E chord, with a top note of B2, triggered by the computer key ‘3’.
Measure 30 is a E chord, with a top note of E3, triggered by the computer key ‘4’.
Measure 31 is a E chord, with a top note of G#3, triggered by the computer key ‘5’.
Measure 32 is a E chord, with a top note of B3, triggered by the computer key ‘6’.
   FIG. 12
Measure 33 is a E chord, with a top note of E4, triggered by the computer key ‘7’.
Measure 34 is a E chord, with a top note of G#4, triggered by the computer key ‘8’.
Measure 35 is an A chord, with a top note of C#3, triggered by the computer key ‘9’.
Measure 36 is an A chord, with a top note of E3, triggered by the computer key ‘0’.
Measure 37 is an A chord, with a top note of A3, triggered by the computer key ‘−’.
Measure 38 is an A chord, with a top note of A2, triggered by the computer key “‘”.
Measure 39 is a A chord, with a top note of C#4, triggered by the computer key ‘,’.
Measure 40 is an A chord, with a top note of E4, triggered by the computer key ‘.’.
   FIG. 13
Measure 41 is an A chord, with a top note of A4, triggered by the computer key ‘/’.
Measure 42 is a D chord, with a top note of A2, triggered by the computer key ‘u’.
Measure 43 is a D chord, with a top note of D3, triggered by the computer key ‘v’.
Measure 44 is a D chord, with a top note of F#3, triggered by the computer key ‘w’.
Measure 45 is a D chord, with a top note of A3, triggered by the computer key ‘x’.
Measure 46 is a D chord, with a top note of D4, triggered by the computer key ‘y’.
Measure 47 is a D chord, with a top note of F#4, triggered by the computer key ‘z’.
Measure 48 is a D chord, with a top note of A4, triggered by the computer key ‘1’.
   FIG. 14
Measure 49 is an E minor chord, with a top note of B2, triggered by the computer key ‘_’.
Measure 50 is an E minor chord, with a top note of E3, triggered by the computer key ‘<’.
Measure 51 is an E minor chord, with a top note of G3, triggered by the computer key ‘>’.
Measure 52 is an E minor chord, with a top note of B3, triggered by the computer key ‘?’.
Measure 53 is an E minor chord, with a top note of E4, triggered by the computer key‘;’.
Measure 54 is an E minor chord, with a top note of G4, triggered by the computer key ‘{’.
Measure 55 is an A Minor chord, with a top note of A2, triggered by the computer key ‘|’.
Measure 56 is an A minor chord, with a top note of C3, triggered by the computer key ‘}’.
Measure 57 is an A minor chord, with a top note of E3, triggered by the computer key ‘+’.
Measure 58 is an A minor chord, with a top note of A3, triggered by the computer key ‘]’.
Measure 59 is an A minor chord, with a top note of C4, triggered by the computer key ‘!’.
Measure 60 is an A minor chord, with a top note of E4, triggered by the computer key ‘@’.
   FIG. 15
Measure 61 is an A minor chord, with a top note of A4, triggered by the computer key ‘#’.
   FIG. 16—Single Note Configurations:
Measure 1 is a single G note in octave 2, and is triggered by the computer key ‘A’.
Measure 2 is a single Ab note in octave 2, and is triggered by the computer key ‘Q’.
Measure 3 is a single A note in octave 2, and is triggered by the computer key ‘B’.
Measure 4 is a single Bb note in octave 2, and is triggered by the computer key ‘R’.
Measure 5 is a single B note in octave 2, and is triggered by the computer key ‘C’.
Measure 6 is a single C note in octave 3, and is triggered by the computer key ‘D’.
Measure 7 is a single C# note in octave 3, and is triggered by the computer key ‘S’.
Measure 8 is a single D note in octave 3, and is triggered by the computer key ‘E’.
Measure 9 is a single Eb note in octave 3, and is triggered by the computer key ‘T’.
Measure 10 is a single E note in octave 3, and is triggered by the computer key ‘F’.
Measure 11 is a single F note in octave 3, and is triggered by the computer key ‘G’.
Measure 12 is a single F# or Gb note in octave 3, and is triggered by the computer key ‘U’.
Measure 13 is a single G note in octave 3, and is triggered by the computer key ‘H’.
Measure 14 is a single Ab note in octave 3, and is triggered by the computer key ‘V’.
Measure 15 is a single A note in octave 3, and is triggered by the computer key ‘I’.
Measure 16 is a single Bb note in octave 3, and is triggered by the computer key ‘W’.
Measure 17 is a single B note in octave 3, and is triggered by the computer key ‘J’.
Measure 18 is a single C note in octave 4, and is triggered by the computer key ‘K’.
Measure 19 is a single C# note in octave 4, and is triggered by the computer key ‘X’.
Measure 20 is a single D note in octave 4, and is triggered by the computer key ‘L’.
Measure 21 is a single Eb note in octave 4, and is triggered by the computer key ‘Y’.
Measure 22 is a single E note in octave 4, and is triggered by the computer key ‘M’.
Measure 23 is a single F note in octave 4, and is triggered by the computer key ‘N’.
Measure 24 is a single F# or Gb note in octave 4, and is triggered by the computer key ‘Z’.
Measure 25 is a single G note in octave 4, and is triggered by the computer key ‘O’.
Measure 26 is a single Ab note in octave 4, and is triggered by the computer key ‘$’.
Measure 27 is a single A note in octave 4, and is triggered by the computer key ‘P’.
   FIG. 17—Opening Screen

The opening screen shows the logos of Type That Tune and MusicType, along with the phrase, “Anyone can play the piano with”, followed by “MusicType”. Beneath the logos are three buttons for point-and-click, respectively, Record, PlayBack, and Play With Trace. The right side of the screen features two scroll downs; the upper one titled “Select Song Category”. The lower part of the right side of the screen features a piano keyboard.

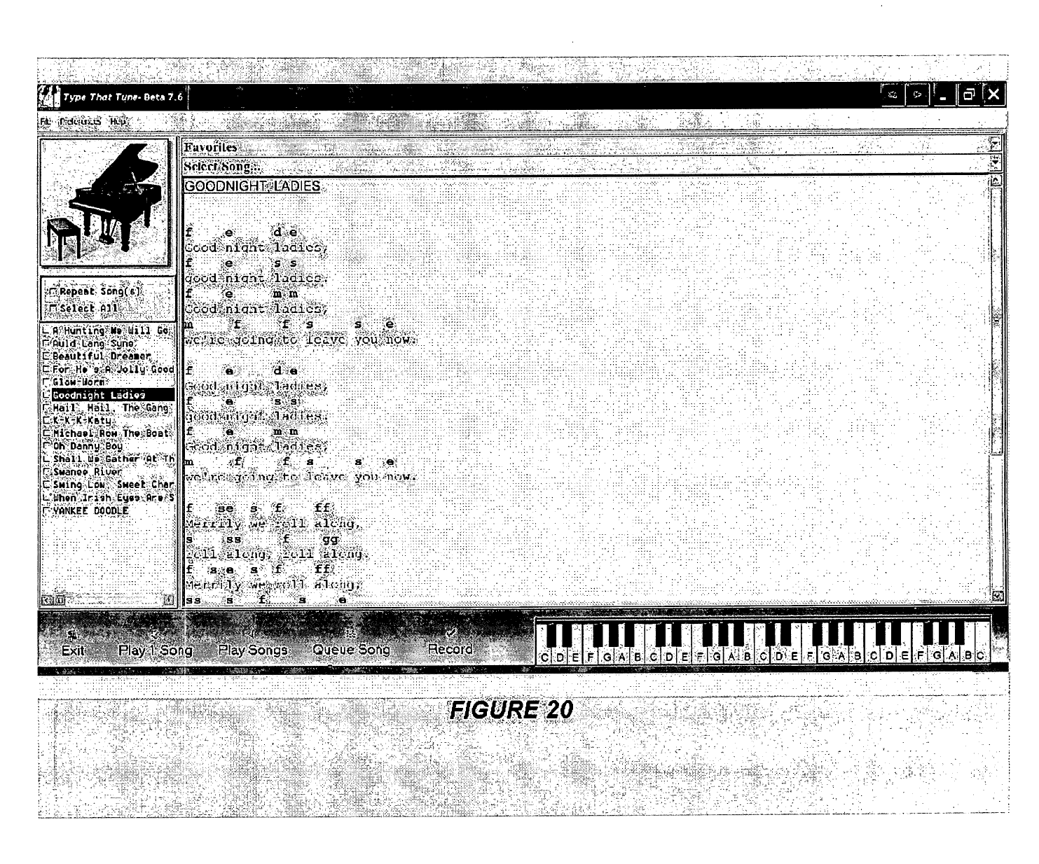

FIG. 18—Song Category

When the Select Song Category box is clicked, a window scrolls down with a list of song categories. FIG. 18 shows the Select Song Category in the down position.

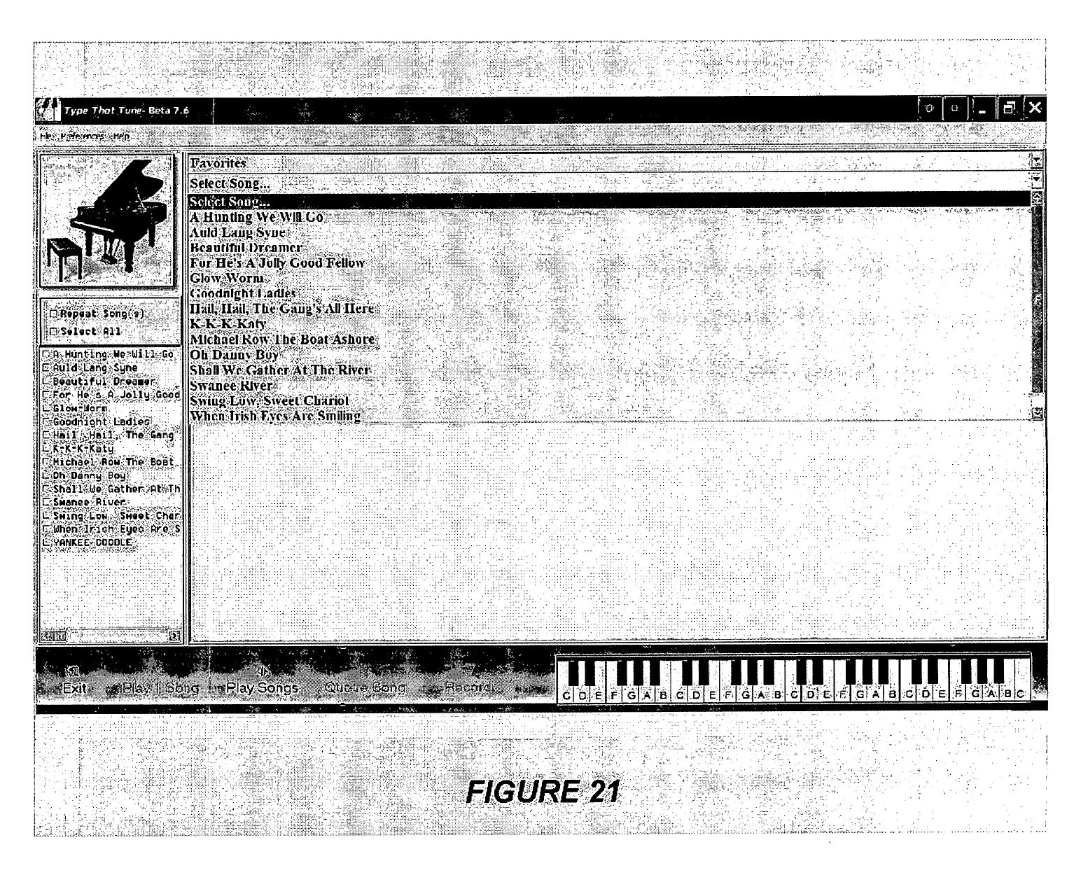

FIG. 19—Select Song

When a song category is selected by clicking on the category title, the window closes, leaving the name of the selected category in the upper box. “Select Song” appears in the lower box. When that box is clicked on, a window scrolls down revealing the titles of songs listed in that category. When the title of a selected song is clicked on, the lyrics and symbols appear for that song for the user to play from the computer keyboard. As an example, FIG. 19 shows the screen with the lyric and symbols for the song “The First Noel”.

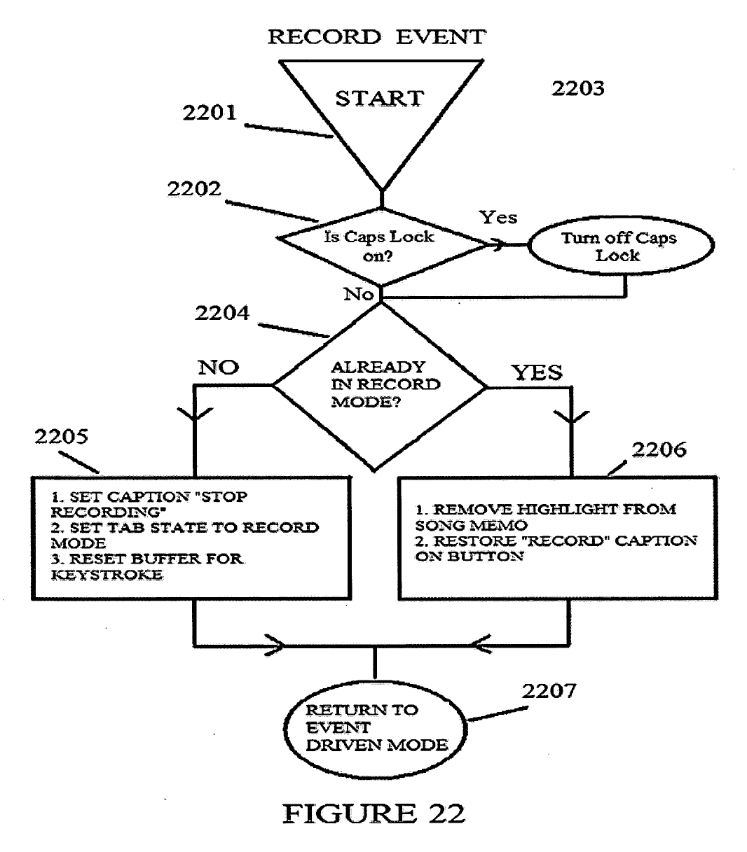

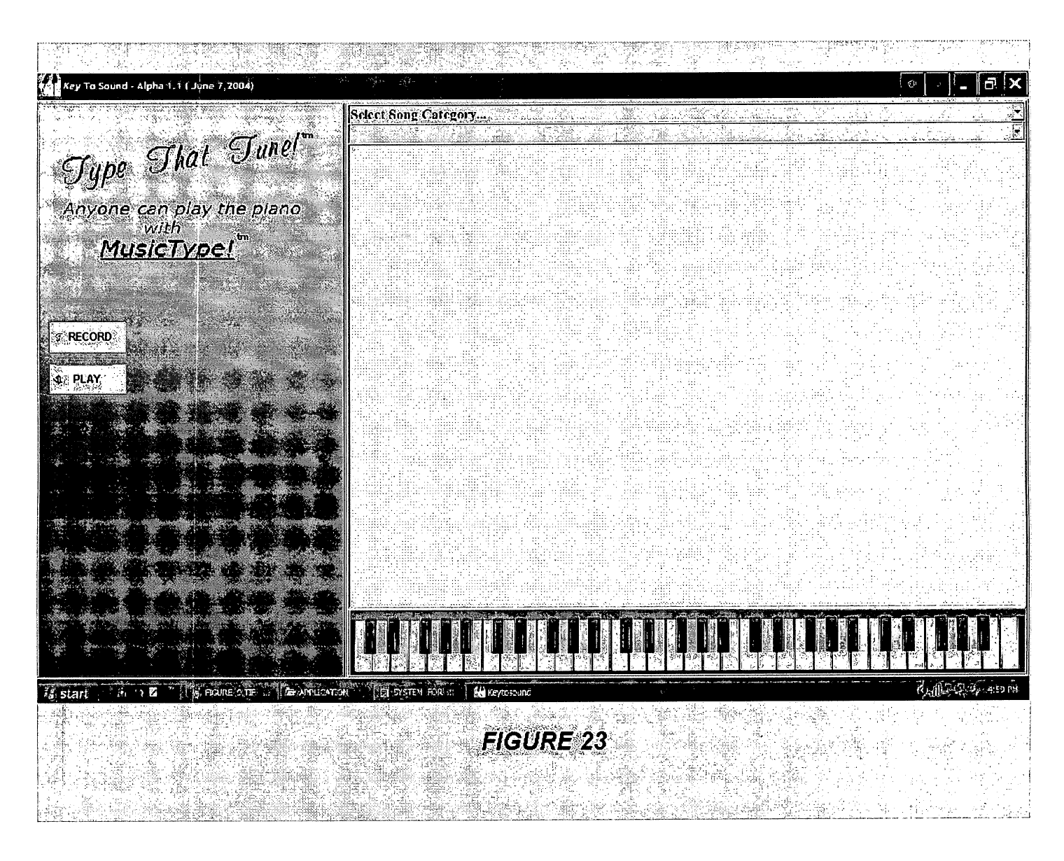

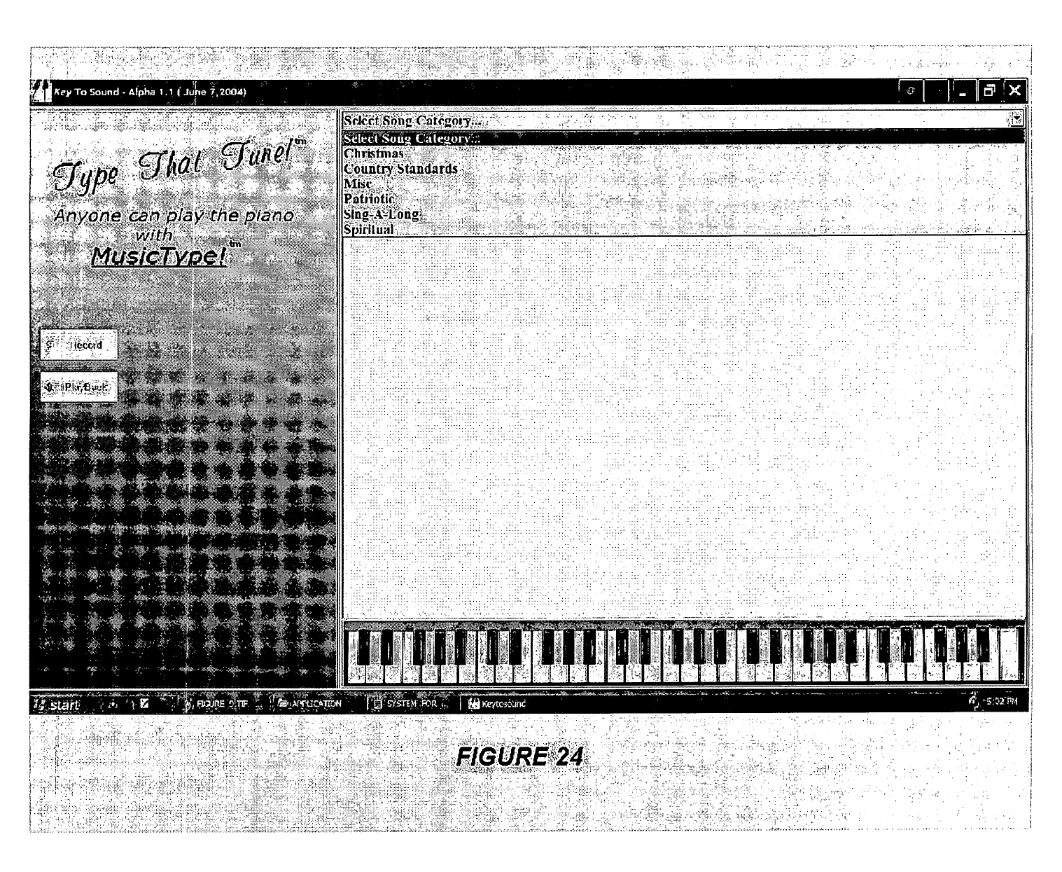

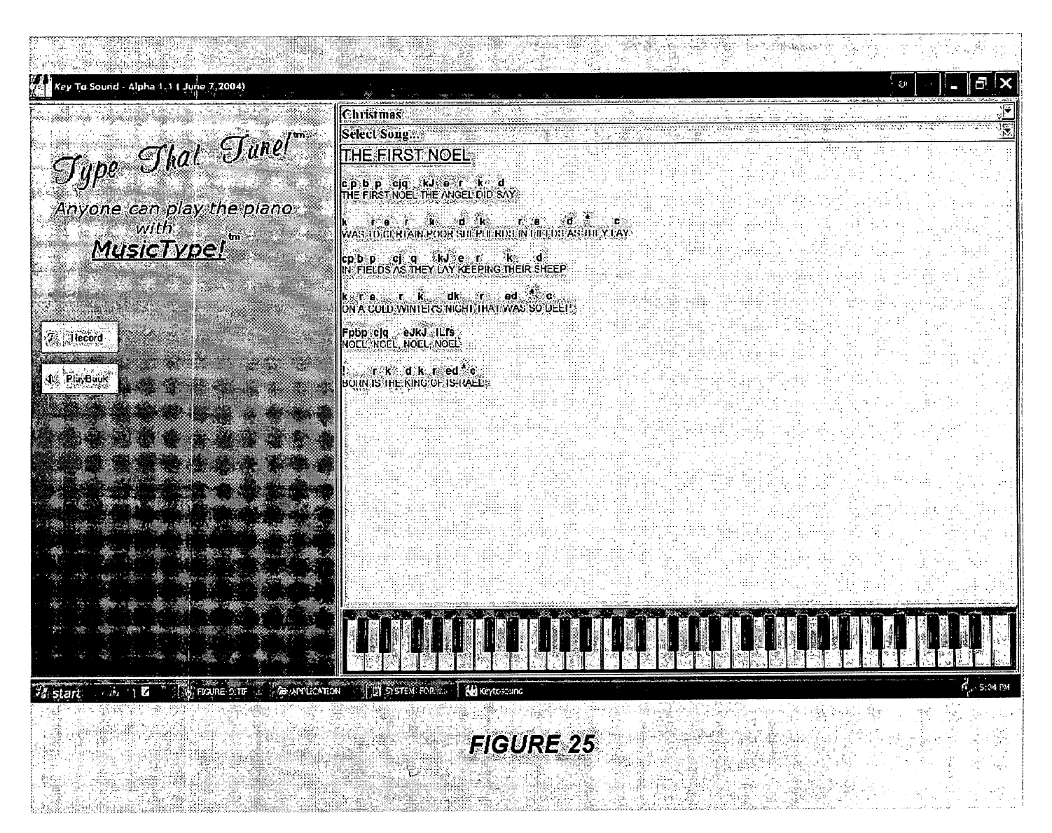

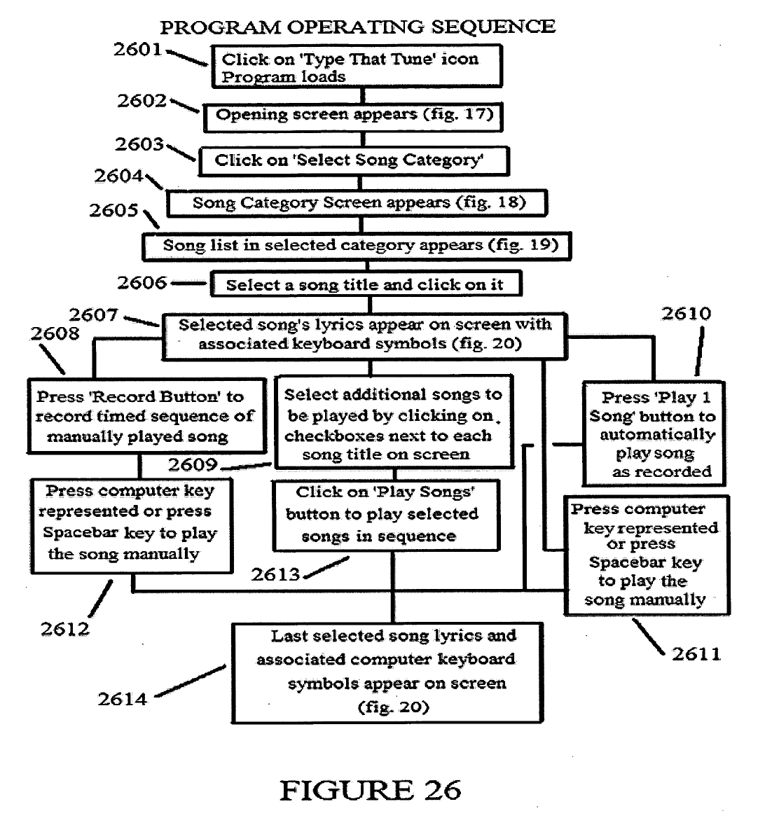

FIG. 20—A preferred embodiment of computer program screen with no options selected.

The preferred opening screen shows the grand piano logo along with check boxes for “Repeat Song” and “Select All”. The Select Song drop down screen is visible in the upper center of the screen. The buttons “Play 1 Song” and “Play Songs” are at the bottom of the screen. A piano keyboard appears at the lower right of the screen.

FIG. 21—A preferred embodiment of computer program screen showing sample drop down menu. This menu is a list of songs chosen from the song category menu. The list automatically appears at the left of the screen in addition to being listed on the drop down menu.

FIG. 22—A preferred embodiment of computer program screen showing a selected song. The song chosen from the song list features the lyrics of the song, along with the computer keyboard symbols above the appropriate word syllables.

FIG. 23—A chart showing an example of computer keyboard relationships to data files with reference to a musical instrument keyboard. Across the top of the chart are musical keys from the musical keyboard. Down the left side of the chart are chordal modes, such as the major and minor chords in various keys. The asterisks represent piano keys in a graphic depiction, the red ones corresponding to the white keys and the black ones corresponding to the black keys. The computer key symbols appear above the asterisks, with the top row describing the top note of the chord sounded and the column at the left describing the chorded sounded. The row across the bottom of the chart are the respective computer symbols corresponding to single notes.

FIG. 24—Record Event Flow Chart With Caps Lock Test

Upon entering the “Record Event” algorithm,
the computer is instructed to check to determine if the Caps Lock function is on or off.
If the Cap Locks function is on, it is turned off
Shut off the Caps Lock function
The computer is then instructed to to check to determine if the computer is or is not in the Record Mode.
If the Record Mode is on, the computer is instructed to
Remove Highlighting from a displayed Song Memo indication
and
Restore the “Record” caption on a displayed button.
Return to the Event Driven Mode.
If the Record Mode is NOT on,
Set Caption to “Stop Recording”
Set state to record mode
Reset Buffer for Key Stroke save.

### DETAILED DESCRIPTION OF INVENTION

Note: In this section, all “2600” numbers refer to components in FIG. 26.

After double clicking the Type That Tune icon, the program will load (2601). The opening screen (FIG. 17) will appear (2602). User clicks on the ‘Select Song Category’ (2603), and a drop down screen appears with a list of song categories (FIG. 18)(2604). User clicks on a song category and a drop down screen appears with a list of songs within that category (FIG. 19)(2605). An identical list appears in a reference window at the left of the screen. User clicks on a song (2606) and a song lyric appears for the song selected (FIG. 20)(2607). Above each word in the lyric are computer keyboard or typewriter keyboard symbols. User has the option to press the computer key for the symbol indicated to produce a polyphonic chord or single note for that word or for a syllable within that word (2611). Pressing each computer key symbol progressively throughout the entire song lyric emulates the sound of a pianist or musician performing a two handed arrangement for the selected song. User can then choose another song or song category and perform another selection.

Another option for User is to press the Space Bar in substitution for any computer keyboard key whose symbol is represented on the lyric of any song (2611). In this way User can perform the entire arrangement using only the Space Bar, with attention only given to the timing or tempo of the selected song arrangement, or the User can use the Space Bar as a substitute for any computer keyboard key not known to User.

Another option for User is to press the ‘Play 1 Song’ button (2610) for automatic play of the song selected from a prerecorded sequence. If user clicks on check boxes located to the left of each song title in the reference window for the song category selected (2609), he or she can have all checked songs played automatically by clicking on the ‘Play Songs’ button (2613).

Another option for User is to use the program as a stand alone musical instrument without the visual song category and song lyric aids. The program will respond to key touch as soon as it comes up on the screen.

Clicking on the ‘Repeat Songs’ button located above the reference window allows for continuous play of the checked songs.

A piano keyboard, located at the bottom right of the screen, highlights the notes of each chord or single note heard as the User plays through the selection. User can also strike a computer key and see the chord or single note heard independent of the song selected. User can also point and click on a key on the piano keyboard graphic to produce the sound of that note. The notes of each piano key are labeled on the piano keyboard graphic.

User also has the option to record his or her own version of a song or to create an arrangement of another song not represented in the Type That Tune program (2608). To record a song, user clicks on the ‘Record’ button. User can then perform a sequence of notes (2612), which will be played back by clicking the ‘Play 1 Song’ button.

If User right clicks, a window appears giving the User several options regarding the program display. Options include whether or not to display the piano keyboard, ignore mistakes as a selection is being performed, place the tool bar on the bottom or top, and font size selection for the song lyrics represented. In addition, User can elect to display tabs that enable User to see program information and to see the tablature used to create the program (FIG. 21). This tablature is a useful tool that shows the relationship between the chord and single note sounds and the symbols on the computer keyboard, which can be useful in the programming of additional song arrangements.

The above disclosure is not intended to limit the scope of this invention including the following considerations:

Any sound or combination may be stored in the lookup tables.

Any chord or note combination may be represented by any single computer key.

Any format may be used for storage of called up notes or chords (wav/mp3, etc).

None of the above disclosure is meant to limit the means by which said software routines or flowcharts, said single noted and polyphonic chords key assignments and /or said computer display screen examples may be configured in this invention.

What I claim is:

1. A system for performing music and musical accompianament comprised of
a personal computer, a standard computer keyboard, a software program and a set of pre-recorded musical samples in which said program allows one not skilled in the art of musical performance to perform polyphonic musical compositions by reading a series of single key defined notes and/or chords and typing said single keys on said computer keyboard.

2. A system as described in claim 1 in which said software program is comprised of the following routines:
Initialization Routine
When the program starts, it instructs the computer to
1. Read settings from the ini file.
2. Load Trade Mark bitmap from disk or memory.
3. Load piano keyboard bitmap from disk or memory.
4. Load piano keys depress bitmap from disk or memory.
5. Identify song categories from song folders.
6. Identify song titles from files within each folder
7. Populate two combo boxes from items 5 and 6 above.
After initilization, the computer is instructed to look for two commands:
1. Load chord files into ram and go to the Event Driven Mode or
2. Go directly to the Event Driven Mode
Record Event Routine
Upon entering the “Record Event” algorithm,
the computer is instructed to check to determine if the Caps Lock function is on or off.
If the Cap Locks function is on, it is turned off
Shut off the Caps Lock function
The computer is then instructed to to check to determine if the computer is or is not in the Record Mode.
If the Record Mode is on, the computer is instructed to
1. Remove Highlighting from a displayed Song Memo indication and
2. Restore the “Record” caption on a displayed button.
3. Return to the Event Driven Mode.
If the Record Mode is NOT on,
Set Caption to “Stop Recording”
Set state to record mode
Reset Buffer for Key Stroke save.
Key Down Routine
Upon entering the “Key Down Event” algorithm, the computer is instructed to check for a repeated key depression.
If this occurs, it is instructed to return to the “Event Driven” Mode.
If a key is not repeated, it is instructed to
1. Save the value of the time at which the key was depressed.
2. Save the Virtual Key Code. and
3. Set the computer to the “Key Down” state.
Key Press Event Flow Routine
When a key is pressed, if it is the space bar and the system is in the “Record” or “Play with Trace Mode”, the next sequential key to be depressed on the keyboard is computed from the Song Text, the corresponding note or chord is played and the system is returned to the “Event Driven” mode.
If the space bar or another key is depressed and the computer is not in the “Record” or “Play With Trace” mode, a chord is automatically selected from the Song Text, played and the system is returned to the “Event Driven” Mode.
If the proper character has been depressed, the on screen symbol corresponding to that character is highlighted and the system is returned to the “Event Driven” Mode.
If the incorrect character has been depressed, an error message is displayed and the system is returned to the “Event Driven” Mode.
Key Up Routine
When a key is released, the “Key Down” state is reset and the keyboard is checked for depression of the shift key.
If the shift key is depressed, the system is returned to the “Event Driven” Mode.
If the shift key is not depressed and the system is not in the “Record” Mode, it is returned to the “Event Driven” Mode.
If the shift key is not depressed and the system is in the “Record” Mode, it retrieves the “Key Up” time, and saves the currently selected Key Character with its associated timing information including “Key Down” and “Key Up” event times.
The system is then returned to the “Event Driven” Mode.
Playback Event Routine
When the “Playback” Button on the screen is selected and the system is in the “Playback” Mode
1. The highlight is removed from the Song Memo.
2. The “Playback” caption is restored to the “Playback” button.
3. The Tag state is restored on the “Playback” button. and the system is returned to the “Event Driven” Mode.
When the “Playback” Button on the screen is selected and the system is not in the “Playback” Mode
1. A “Stop Playback” caption is displayed on the screen.
2. The Tag state is set to Playback Mode.
3. A Thread is started to Playback the Song. and system is then returned to the “Event Driven” Mode.
Play With Trace Routine
When the system is in the “Record” or “Playback” Mode, a scan is made to check for activation of the keyboard's Caps Lock function.
If the Caps Lock function is on, it is turned off
The system is then checked if it is already in the “play With Trace” Mode.
If in this mode,
1. The highlight is removed from the Song Memo display.
2. The “Play With Trace” is restored to the button.
3. The system is returned to the “Event Driven” Mode.
If not in the “Play With Trace” Mode,
1. A “Stop Playing” caption is displayed.
2. The Tag state is set to “Trace Play” Mode.
3. A Thread is started to Queue the Song.
4. The system is returned to the “Event Driven” Mode.
Play Chord Routine
The “Play Chord” routine mutes any notes or chords occuring when a new key is depressed, locates the new corresponding note or chord in RAM, plays the selected notes, paints these notes selectively on a screen displayed piano keyboard and returns the system to the “Event Driven” Mode.

3. A system as described in claim 2 in which said polyphonic chords and single notes are represented as followa
(Measures are numbered 1-61 and 1-26 respectively. Numbers following note designations denote the octave in which the note appears on the piano keyboard, with middle C being the first note of octave 3.)
a C chord, with a top note of G2, triggered by the computer key ‘a’.
a C chord, with a top note of C3, triggered by the computer key ‘b’.
a C chord, with a top note of E3, triggered by the computer key ‘c’.
a C chord, with a top note of G3, triggered by the computer key ‘d’.
a C chord, with a top note of C4, triggered by the computer key ‘e’.
a C chord, with a top note of E4, triggered by the computer key ‘f’.
a C chord, with a top note of G4, triggered by the computer key ‘g’.
an F chord, with a top note of A2, triggered by the computer key ‘h’.
an F chord, with a top note of C3, triggered by the computer key ‘i’.
an F chord, with a top note of F3, triggered by the computer key ‘j’.
an F chord, with a top note of A3, triggered by the computer key ‘k’.
an F chord, with a top note of C4, triggered by the computer key ‘l’.
an F chord, with a top note of F4, triggered by the computer key ‘m’.
an F chord, with a top note of A4, triggered by the computer key ‘n’.
a G chord, with a top note of B2, triggered by the computer key ‘o’.
a G chord, with a top note of D3, triggered by the computer key ‘p’.
a G chord, with a top note of G3, triggered by the computer key ‘q’.
a G chord, with a top note of B3, triggered by the computer key ‘r’.
a G chord, with a top note of D4, triggered by the computer key ‘s’.
a G chord, with a top note of G4, triggered by the computer key ‘t’.
a D chord, with a top note of A2, triggered by the computer key ‘u’.
a D chord, with a top note of D3, triggered by the computer key ‘v’.
a D chord, with a top note of F#3, triggered by the computer key ‘w’.
a D chord, with a top note of A3, triggered by the computer key ‘x’.
a D chord, with a top note of D4, triggered by the computer key ‘y’.
a D chord, with a top note of F#4, triggered by the computer key ‘z’.
a D chord, with a top note of A4, triggered by the computer key ‘1’.
an E chord, with a top note of G#2, triggered by the computer key ‘2’.
a E chord, with a top note of B2, triggered by the computer key ‘3’.
a E chord, with a top note of E3, triggered by the computer key ‘4’.
a E chord, with a top note of G#3, triggered by the computer key ‘5’.
a E chord, with a top note of B3, triggered by the computer key ‘6’.
a E chord, with a top note of E4, triggered by the computer key ‘7’.
a E chord, with a top note of G#4, triggered by the computer key ‘8’.
an A chord, with a top note of C#3, triggered by the computer key ‘9’.
an A chord, with a top note of E3, triggered by the computer key ‘0’.
an A chord, with a top note of A3, triggered by the computer key ‘−’.
an A chord, with a top note of A2, triggered by the computer key “‘”.
a A chord, with a top note of C#4, triggered by the computer key ‘,’.
an A chord, with a top note of E4, triggered by the computer key ‘.’.
an A chord, with a top note of A4, triggered by the computer key ‘/’.
a D chord, with a top note of A2, triggered by the computer key ‘u’.
a D chord, with a top note of D3, triggered by the computer key ‘v’.
a D chord, with a top note of F#3, triggered by the computer key ‘w’.
a D chord, with a top note of A3, triggered by the computer key ‘x’.
a D chord, with a top note of D4, triggered by the computer key ‘y’.
a D chord, with a top note of F#4, triggered by the computer key ‘z’.
a D chord, with a top note of A4, triggered by the computer key ‘1’.
an E minor chord, with a top note of B2, triggered by the computer key ‘_’.
an E minor chord, with a top note of E3, triggered by the computer key ‘<’.
an E minor chord, with a top note of G3, triggered by the computer key ‘>’.
an E minor chord, with a top note of B3, triggered by the computer key ‘?’.
an E minor chord, with a top note of E4, triggered by the computer key ‘;’.
an E minor chord, with a top note of G4, triggered by the computer key ‘{’.
an A Minor chord, with a top note of A2, triggered by the computer key ‘|’.
an A minor chord, with a top note of C3, triggered by the computer key ‘}’.
an A minor chord, with a top note of E3, triggered by the computer key ‘+’.
an A minor chord, with a top note of A3, triggered by the computer key ‘]’.
an A minor chord, with a top note of C4, triggered by the computer key ‘!’.
an A minor chord, with a top note of E4, triggered by the computer key ‘@’.
an A minor chord, with a top note of A4, triggered by the computer key ‘#’.
Single Note Key Assignments
a single G note in octave 2, and is triggered by the computer key ‘A’.
a single Ab note in octave 2, and is triggered by the computer key ‘Q’.
a single A note in octave 2, and is triggered by the computer key ‘B’.
a single Bb note in octave 2, and is triggered by the computer key ‘R’.
a single B note in octave 2, and is triggered by the computer key ‘C’.
a single C note in octave 3, and is triggered by the computer key ‘D’.
a single C# note in octave 3, and is triggered by the computer key ‘S’.
a single D note in octave 3, and is triggered by the computer key ‘E’.
a single Eb note in octave 3, and is triggered by the computer key ‘T’.
a single E note in octave 3, and is triggered by the computer key ‘F’.
a single F note in octave 3, and is triggered by the computer key ‘G’.
a single F# or Gb note in octave 3, and is triggered by the computer key ‘U’.
a single G note in octave 3, and is triggered by the computer key ‘H’.
a single Ab note in octave 3, and is triggered by the computer key ‘V’.
a single A note in octave 3, and is triggered by the computer key ‘I’.
a single Bb note in octave 3, and is triggered by the computer key ‘W’.
a single B note in octave 3, and is triggered by the computer key ‘J’.
a single C note in octave 4, and is triggered by the computer key ‘K’.
a single C# note in octave 4, and is triggered by the computer key ‘X’.
a single D note in octave 4, and is triggered by the computer key ‘L’.
a single Eb note in octave 4, and is triggered by the computer key ‘Y’.
a single E note in octave 4, and is triggered by the computer key ‘M’.
a single F note in octave 4, and is triggered by the computer key ‘N’.
a single F# or Gb note in octave 4, and is triggered by the computer key ‘Z’.
a single G note in octave 4, and is triggered by the computer key ‘O’.
a single Ab note in octave 4, and is triggered by the computer key ‘$’.
a single A note in octave 4, and is triggered by the computer key ‘P’.

4. A system described in claim 1 in which said polyphonic chords and single notes are reproduced via a MIDI system.

5. A system described in claim 2 in which said polyphonic chords and single notes are reproduced via a MIDI system.

6. A system described in claim 3 in which said polyphonic chords and single notes are reproduced via a MIDI system.

7. A system described in claim 1 in which an opening display screen displays two buttons, Record and PlayBack, two scroll down displays which are respectively titled “Select Song Category” and “Song Select” and a display of a piano keyboard
in which selection of “Select Song Category” allows a means for a user to select from a library of song categories or genres and then select a specific song or composition by activating the “Song Select” button to either manually play or have automatically played as a pre-recorded sequence.

8. A system described in claim 2 in which an opening display screen displays two buttons, Record and PlayBack, two scroll down displays which are respectively titled “Select Song Category” and “Song Select” and a display of a piano keyboard
in which selection of “Select Song Category” allows a means for a user to select from a library of song categories or genres and then select a specific song or composition by activating the “Song Select” button to either manually play or have automatically played as a pre-recorded sequence.

9. A system described in claim 3 in which an opening display screen displays two buttons, Record and PlayBack, two scroll down displays which are respectively titled “Select Song Category” and “Song Select” and a display of a piano keyboard i
n which selection of “Select Song Category” allows a means for a user to select from a library of song categories or genres and then select a specific song or composition by activating the “Song Select” button to either manually play or have automatically played as a pre-recorded sequence.
